(19) United States
(12) Patent Application Publication
(10) Pub. No.: US 2023/0030183 A1
(43) Pub. Date: Feb. 2, 2023

(54) ALARM COMMUNICATION DEVICE, COMMUNICATION SYSTEM, ALARM COMMUNICATION METHOD, AND ALARM COMMUNICATION PROGRAM

(71) Applicant: Nippon Telegraph and Telephone Corporation, Tokyo (JP)

(72) Inventors: Minoru Yamaguchi, Musashino-shi, Tokyo (JP); Yoshinori Koike, Musashino-shi, Tokyo (JP); Hirotaka YOSHIOKA, Musashino-shi, Tokyo (JP)

(21) Appl. No.: 17/619,068

(22) PCT Filed: Jun. 28, 2019
(86) PCT No.: PCT/JP2019/025972

§ 371 Date: Aug. 15, 2022

(51) Int. Cl. H04B 10/077

(52) U.S. Cl. CPC H04B 10/077

(57) ABSTRACT

A domain A (10) including one or more boundary nodes (13) is provided with a VIF (13v) which is a virtual connection unit for virtual connection with an adjacent domain B (20), and the domain B (20) including one or more boundary nodes (21) is provided with a VIF (21v) which is a virtual connection unit for virtual connection with the domain A (10), in which the boundary node (13) notifies the VIF (21v) adjacent to the VIF (13v) of a VIF warning by receiving an internal warning in a format capable of being processed within the domain A (10), and converting the internal warning into the VIF warning which is a warning of the VIF (13v) capable of being processed in common between the domains, and the boundary node (21) transfers the internal warning to another node within the domain B (20) by converting the VIF warning of the VIF (21v) into an internal warning in a format capable of being processed within the domain B (20).

### TECHNICAL FIELD

The present invention relates to a warning communication device, a communication system, a warning communication method, and a warning communication program.

### BACKGROUND ART

A standardized organization international telecommunication union telecommunication standardization sector (ITU-T) specifies a warning transfer function for transferring a warning signal related to a main signal for which the wavelength is multiplexed between node devices using an optical supervisory channel (OSC), which is a wavelength for monitoring, as a recommendation related to an optical transport network (OTN) (Non Patent Literature 1).

By using this warning transfer function, a downstream device or an upstream reverse device (a downstream device in the reverse direction) is notified of a fault, the occurrence of repeated warnings or erroneous recognition of a fault is suppressed, and a communication path is switched.

Reconstruction of a system having a warning transfer function in order to cope with a case where communication devices of different vendors are to be connected or a case where the lifecycle of a product differs between each component (an optical cross connector unit, an optical multiplexer/demultiplexer unit, an optical amplification unit, or the like) of a communication device and an optical transmission and reception unit connected to the communication device, is being considered. The following is an example of a reconstructed system.

A system in which a different optical transmission and reception unit is connected to a communication device.
A system in which separate devices are provided for respective components of a communication device.
A common data model for reconstructing these systems (Non Patent Literatures 2 and 3) and a connection technique (Non Patent Literature 4) have been examined.

### CITATION LIST Non Patent Literature

Non Patent Literature 1: ITU-T, “G.709/Y.1331: Interfaces for the Optical Transport Network”, [online]; Jun. 22, 2016, [Searched on Jun. 19, 2019], internet

<URL: https://www.itu.int/rec/dologin_pub.asp?lang=e&id=T-REC-G.709-201606-I!! PDF-E&type=items>

Non Patent Literature 2: OpenConfig, “OpenConfig Vendor-neutral, Model-driven Network Management Designed by Users” [online], 2016, [searched on Jun. 19, 2019], Internet

(URL: http://www.openconfig.net/)

Non Patent Literature 3: The Open ROADM Multi-Source Agreement (MSA), “Open ROADM”, [online], 2016, [searched on 19 Jun., 2019], the Internet

<URL: http://openroadm.org/home.html>

Non Patent Literature 4: Infinera, “Open Line Systems and Open ROADM: How Open Is Your Line System?”, [online], 2018, [searched Jun. 19, 2019], Internet: URL:

https://tnc18.geant.org/getfile/4520>

### SUMMARY OF THE INVENTION

### Technical Problem

Each network constructor or each device manufacturer decides upon a detailed implementation method for a warning transfer function by himself or herself. The implementation method is, for example, a signal wavelength of an OSC, a bit sequence of a warning signal of an OTN frame, or the like, and a different implementation is often performed even in a case where the implementation is based on a recommendation related to an OTN of an ITU-T. Thus, a warning cannot also be transferred between different optical networks due to a difference in implementation in some cases.

FIG. 9 is a diagram illustrating a warning issued from one node and reaching a higher-level control device.

A first domain (a control device X, and nodes X1, X2, and X3) and a second domain (a control device Y, and nodes Y1, Y2, and Y3) are different optical networks. The higher-level control device is connected to the control devices X and Y in order to mediate between domains. Hereinafter, the control of a warning in a domain such as the node X1→the node X2→the node X3 is referred to as “in-bound”, and the control of a warning through a higher-level control device such as the node X2→the control device X→the higher control device (a bold arrow in the drawing)→the control device Y→the node Y1 is referred to as “out-bound”.

In a case where it is difficult to transfer a warning between different optical networks, because in-bound monitoring and control is difficult, outbound warnings are issued all at once to a higher-level control device that monitors and controls a plurality of networks. Furthermore, the higher-level control device identifies a cause and suppresses a warning based on a dependency of the warning.

FIG. 10 is a diagram illustrating warnings issued from six nodes and reaching a higher-level control device.

When all of the warnings are out-bound and the number of nodes that issue warnings is increased, the issued warnings are all concentrated on a higher-level control device as indicated by a bold arrow illustrated in the drawing, and thus scalability of the overall system is degraded.

Consequently, a main object of the present invention is to improve the scalability of a control system for a warning which is notified across a plurality of networks.

### Means for Solving the Problem

In order to solve the problem, a warning communication device of the present invention has the following features.

The present invention provides a warning communication device including a first node and a second node, a plurality of the first nodes being included in a first domain having a first virtual IF which is a virtual connection unit for virtual connection with an adjacent second domain having a second virtual IF which is a virtual connection unit for virtual connection with the first domain, and a plurality of the second nodes being included in the second domain, in which the first node notifies the second virtual IF adjacent to the first virtual IF of a virtual warning by receiving a first internal warning in a format capable of being processed within the first domain, and converting the first internal warning into the virtual warning which is a warning of a virtual IF capable of being processed in common between the domains, and the second node transfers the second internal warning to another node in the second domain by converting the virtual warning of the second virtual IF into a second internal warning in a format capable of being processed within the second domain.

### Effects of the Invention

According to the present invention, it is possible to improve the scalability of a control system of a warning which is notified across a plurality of networks.

### BRIEF DESCRIPTION OF DRAWINGS

FIG. 1 is a configuration diagram illustrating a communication system according to the present embodiment.

FIG. 2 is a configuration diagram including a management system with respect to the communication system of FIG. 1 according to the present embodiment.

FIG. 3 is a detailed configuration diagram of a boundary node and a VIF management unit in a domain A according to the present embodiment.

FIG. 4 is a detailed configuration diagram of a higher-level control device according to the present embodiment.

FIG. 5 is a detailed configuration diagram of a boundary node and a VIF management unit in a domain B according to the present embodiment.

FIG. 6 is a sequence diagram illustrating an operation of a communication system according to the present embodiment when a warning is generated.

FIG. 7 is a configuration diagram of a table which is used for processing of an abnormality detection unit according to the present embodiment.

FIG. 8 is a configuration diagram of a computer which is used in the communication system according to the present embodiment.

FIG. 9 is a diagram illustrating a warning issued from one node and reaching a higher-level control device.

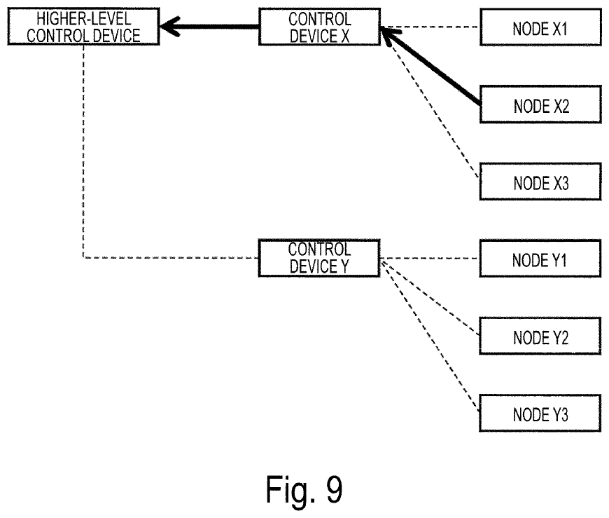

FIG. 10 is a diagram illustrating warnings issued from six nodes and reaching a higher-level control device.

### DESCRIPTION OF EMBODIMENTS

Hereinafter, an embodiment of the present invention will be described in detail with reference to the drawings.

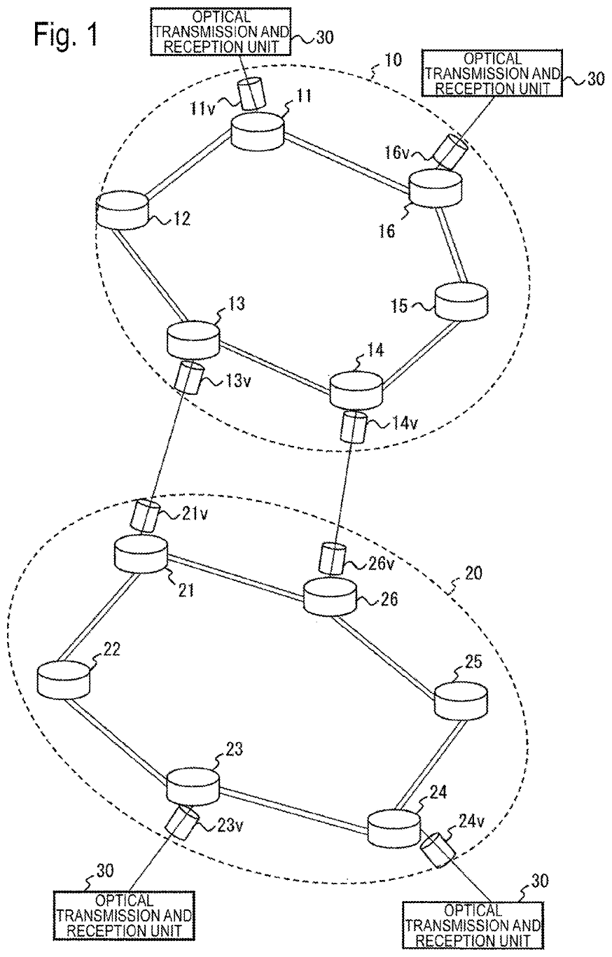

FIG. 1 is a configuration diagram of a communication system.

The communication system is configured as an optical transport system to which a plurality of transmission line systems (a domain A10 which is a first domain in FIG. 1, a domain B20 which is a second domain) are connected. Nodes (first nodes) in the domain A10 have virtually the same single vendor configuration, and nodes (second nodes) in the domain B20 have virtually a single vendor configuration different from the domain A10. Thus, a vendor's own monitoring control system can be used within each of the domain A10 and the domain B20. On the other hand, the overall communication system of FIG. 1 is a multi-vendor system constituted by two vendors.

Each domain also has a connection to an optical transmission and reception unit 30 independent of the domain, in addition to having a connection to the other domain. The optical transmission and reception unit 30 is a device that modulates transmission data into an optical signal for transmission by an optical fiber which is a transmission medium, demodulates the received optical signal, and extracts the received data.

Hereinafter, among nodes in a domain, a node having a connection to the outside (the other domain or the optical transmission and reception unit 30) is referred to as a “boundary node”, and a node that does not correspond to the boundary node is referred to as a “relay node”. For example, the domain A10 includes four boundary nodes 11, 13, 14, and 16 and two relay nodes 12 and 15. The domain B20 has four boundary nodes 21, 23, 24, and 26 and two relay nodes 22 and 25. These nodes are connected by a double ring in the same domain. Note that the double-ring network configuration is merely an example.

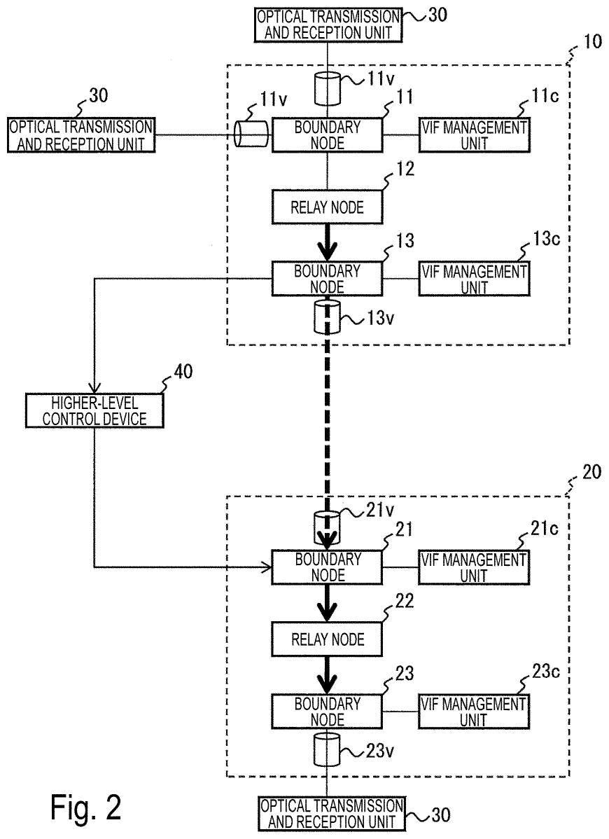

Each boundary node includes a virtual interface (VIF) as a virtual connection part at an endpoint connected to the outside. For example, each boundary node of the domain A10 includes a total of four first virtual IFs (VIFs 11v, 13v, 14v, and 16v). Each boundary node of the domain B20 includes a total of four second virtual IFs (VIFs 21v, 23v, 24v, and 26v). These VIFs are not physically disposed at system endpoints and are virtually installed on a data model handled by a higher-level control device 40 (FIG. 2) of the communication system. For this reason, the higher-level control device 40 maps management information of an actual physical device and management information of a data model to ensure the integrity therebetween.

Each of the VIFs is a virtual interface that has signal information (a modulation method, a modulation rate, a center wavelength, and the like) of a section in which the VIF is virtually installed and state information (no abnormality, loss of signal (LOS), and the like) as information, and makes it appear as if the signal is being transmitted and received.

For example, the VIF 11v is present within domain A10 together with a boundary node 11 and relays an optical signal between the VIF 11v and the optical transmission and reception unit 30 which is the actual connection destination of the boundary node 11. Here, the optical signal input from the optical transmission and reception unit 30 is treated by the boundary node 11 as an optical signal transmitted from the VIF 11v. Thereby, the boundary node 11 is caused to execute autonomous control in in-bound monitoring using actual transmission and reception of a warning to and from the outside (the optical transmission and reception unit 30) as virtual transmission and reception of a warning to and from the inside (the VIF 11v).

Similarly, the boundary node 13 of the domain A10 and the boundary node 21 of the domain B20 are adjacent to each other via the VIF 13v and the VIF 21v. Then, the boundary node 13 may handle a warning issued from the other domain B20 (the boundary node 21) via the VIF 13v of its own domain A10 by in-bound control, as if the warning were a warning issued by its own domain A10. In addition, the boundary node 21 can also handle a warning issued from the other domain A10 via the VIF 21v by in-bound control. By the in-bound control thereof, it is also possible to specify a failure between systems from a VIF state of an adjacent system.

FIG. 2 is a configuration diagram including a management system with respect to the communication system of FIG. 1.

In addition to the nodes described above, the domain A10 includes a VIF management unit 11c for managing the VIF 11v of the boundary node 11 and a VIF management unit 13c for managing the VIF 13v of the boundary node 13. That is, the number of VIFs included in the boundary node is not limited, and one VIF management unit is provided for one boundary node. In addition to the nodes described above, the domain B20 includes a VIF management unit 21c for managing the VIF 21v of the boundary node 21 and a VIF management unit 23c for managing the VIF 23v of the boundary node 23.

Furthermore, the higher-level control device 40 for performing out-bound control of a warning from each domain is also provided as a management system.

A bold solid arrow in FIG. 2 indicates a flow of a warning. A warning issued by the relay node 12 is in-bound controlled by the domain A10 (the relay node 12→the boundary node 13).

Hereinafter, a warning transmitted and received within the same domain is referred to as an “internal warning”, and a warning transmitted and received across domains is referred to as a “VIF warning (virtual warning)”. The term “VIF warning” is intended to generate a pseudo warning, such as an LOS signal, inside a VIF between domains that transmit and receive a warning.

The internal warning is a vendor-dependent format within a domain, and the VIF warning is a common format (standardized by an OTN or the like) which does not depend on a vendor for a domain. The internal warning of the domain A10 is transmitted and received between nodes within the domain A10 constituted by the same vendor.

That is, when an anomaly has been detected in the domain A10, an internal warning is transferred upstream and downstream within the domain A10 through in-bound control. Each of the nodes having received the internal warning executes a process of suppressing the issuance of a warning, a process of separating a cause warning and a spillover warning, a process in the case of an abnormality such as path switching as necessary, and the like, as responses for a warning.

Here, a case where a warning is transferred across a domain from the boundary node 13 to the boundary node 21 is considered (a bold dashed arrow in the drawing). When the domain B20 is notified of the internal warning of the domain A10 as is, in-bound control cannot be performed in the domain B20 due to a difference in vendor.

Thus, the VIF management unit 13c converts a first internal warning of the domain A10 which is transmitted from the VIF 13v, which is to be managed, into a VIF warning of the VIF 13v. Then, the VIF management unit 21c converts the VIF warning received by the VIF 21v, which is to be managed, into a second internal warning of the domain B20. Thereby, a VIF warning transferred from the VIF 13v to the VIF 21v is transmitted and received as an internal warning at the domain B20 (the boundary node 21→the relay node 22→the boundary node 23) (bold solid arrow).

Note that data of an interface such as the VIF 13v may be generated even when the boundary node 13 is not actually present, and data may be provided so that an interface is present at a location where the VIF 13v is virtually installed. In addition, by storing the VIF warning of the VIF 13v in the higher-level control device 40, the VIF 13v may exist only on management data. Then, the warning of the domain A10 in which the VIF 13v is virtually installed is transmitted to the domain B20 as a VIF warning.

On the other hand, on a physical configuration, the VIF management unit 13c is installed within the boundary node 13, and a VIF warning that has aggregated device information within the boundary node 13 is configured to be transferred to the boundary node 21 of the adjacent domain B20 using one wave of a WDM signal as OSC light. At that time, it is assumed that there is the VIF 13v in a portion in contact with the outside of the domain A10.

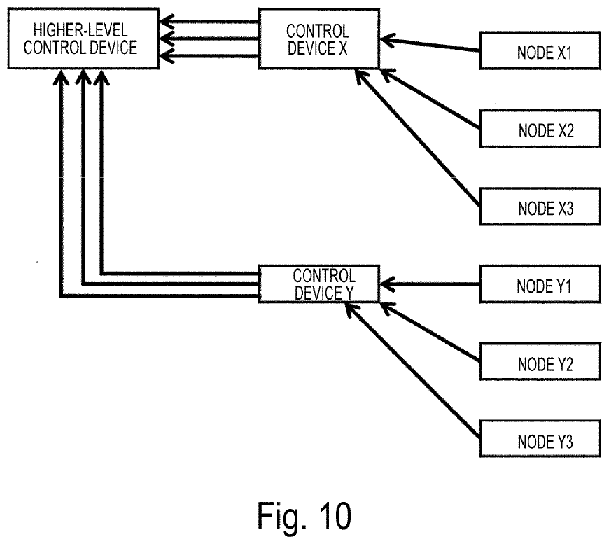

Here, even when out-bound control is performed, the higher-level control device 40 does not need to directly handle the internal warning of each domain. On the other hand, the higher-level control device 40 may transmit and receive a VIF warning between adjacent VIFs (the VIF 13v, the VIF 21v). Thereby, it is possible to prevent a concentration of warnings on the higher-level control device 40 as illustrated in FIG. 10 and to improve scalability of the overall communication system.

That is, it is possible to recover the overall communication system in a short period of time by causing each domain to take charge of in-bound autonomous control and reducing the amount of calculation in the higher-level control device 40. In addition, even when a failure has occurred between the higher-level control device 40 and the domain, a main signal is not blocked, and in-bound control can be autonomously performed. Furthermore, the higher-level control device 40 can unify a monitoring control system into a system common to multiple vendors by handling a VIF warning which is not dependent on a vendor.

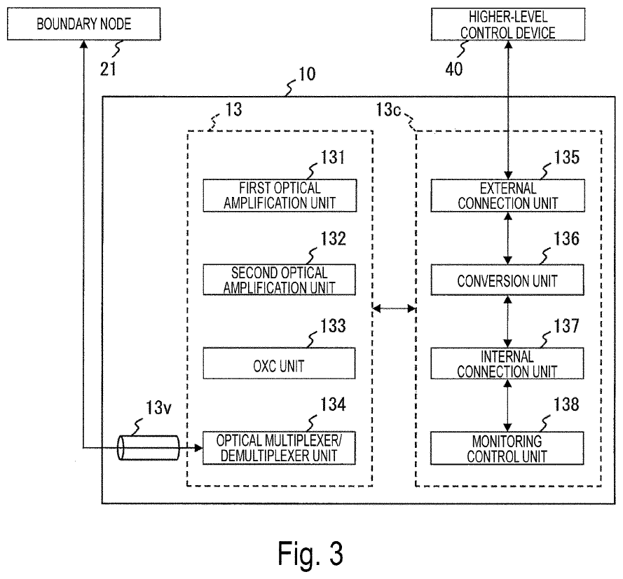

FIG. 3 is a detailed configuration diagram of the boundary node 13 and the VIF management unit 13c. Here, the boundary node 13 and the VIF management unit 13c are illustrated, but other nodes and VIF management units also include the same components or portions thereof.

The boundary node 13 includes a first optical amplification unit 131, a second optical amplification unit 132, an OXC unit 133, and an optical multiplexer/demultiplexer unit 134. The first optical amplification unit 131 and the second optical amplification unit 132 amplify an attenuated optical signal. In the example illustrated in FIG. 1, because the nodes are connected by a double ring, an optical amplification unit is also present for each line (here, two optical amplification units). On the other hand, the present invention is not limited to the double ring, and the number of optical amplification units included in the boundary node 13 is also determined in accordance with the number of lines in a network handled by the boundary node 13.

An optical cross-connect (OXC) unit 133 is an optical cross connect that selects a path in accordance with a wavelength and transmits the selected path to another node without converting an optical signal into an electrical signal.

The optical multiplexer/demultiplexer unit 134 performs wavelength multiplexing (multiplexing) of a plurality of signals received from the OXC unit 133 or separation (demultiplexing) of the signals for each wavelength.

The VIF management unit 13c includes an external connection unit 135, a conversion unit 136, an internal connection unit 137, and a monitoring control unit 138.

The external connection unit 135 acquires a warning from an adjacent external system and passes the warning to the internal connection unit 137. Furthermore, the external connection unit 135 transfers a VIF warning converted by the conversion unit 136 to an adjacent external system. In addition, the external connection unit 135 transfers a VIF warning indicating a failure of a VIF to the adjacent system, and issues a warning for determining the cause of the failure to the higher-level control device 40. Furthermore, the external connection unit 135 gives a notification of a spillover warning when a request is given from the higher-level control device 40.

The conversion unit 136 converts the internal warning into a VIF warning in order to abstract (virtualize) its own domain to the optical transmission and reception unit 30 with respect to an adjacent domain. The VIF warning is a domain-common data model including a normal state (ON/OFF) of an optical signal, an abnormal state warning (LOS/LOF/ . . . ), or the like as monitoring control information of its own domain.

For this reason, the VIF management unit 11c maps the state (device state) of the boundary node 11 to be monitored and the state of the optical transmission and reception unit 30 connected to the boundary node 11 as state information of the VIF 11v to be monitored. Then, the conversion unit 136 performs conversion processing on the internal warning and the VIF warning based on the mapped information.

The internal connection unit 137 has an in-bound monitoring control function as a system endpoint of its own domain. The monitoring control unit 138 transmits and receives a warning signal as a monitoring control function of the internal connection unit 137.

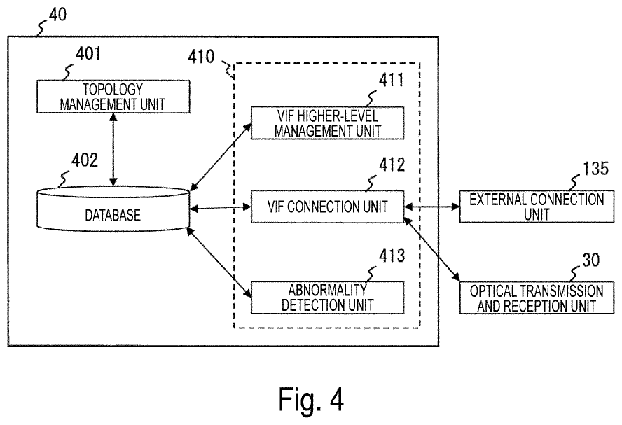

FIG. 4 is a detailed configuration diagram of the higher-level control device 40.

The higher-level control device 40 includes a topology management unit 401, a database 402, and a VIF processing unit 410.

The database 402 stores topology, the actual failure point based on the topology, the states of VIFs, connection information of the VIFs, the state between adjacent VIFs, and the like as management information of a network (the domain A10, the domain B20).

The topology management unit 401 manages the topology stored in the database 402 and appropriately performs updating to the latest information.

The VIF processing unit 410 includes a VIF higher-level management unit 411, a VIF connection unit 412, and an abnormality detection unit 413.

The VIF connection unit 412 acquires a VIF warning or gives a notification of the VIF warning between the VIF connection unit 412 and the external connection unit 135 to which the VIF connection unit 412 is connected.

The VIF higher-level management unit 411 manages which VIFs are adjacent to each other, where a fault has occurred, or the like by collating the topology stored in the database 402 with the VIF warning acquired by the VIF connection unit 412.

The abnormality detection unit 413 compares the states of VIFs that are determined to be adjacent to each other by the VIF higher-level management unit 411, and detects whether or not an abnormality has occurred between the VIFs.

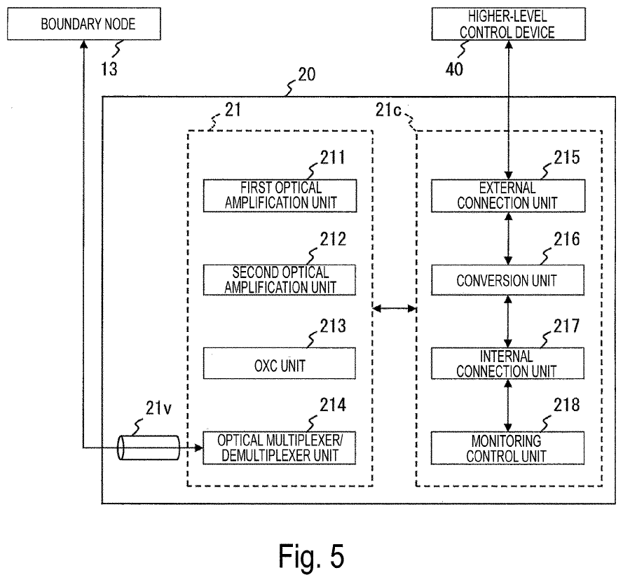

FIG. 5 is a detailed configuration diagram of the boundary node 21 and the VIF management unit 21c.

The boundary node 21 includes a first optical amplification unit 211, a second optical amplification unit 212, an OXC unit 213, and an optical multiplexer/demultiplexer unit 214. The VIF management unit 21c includes an external connection unit 215, a conversion unit 216, an internal connection unit 217, and a monitoring control unit 218.

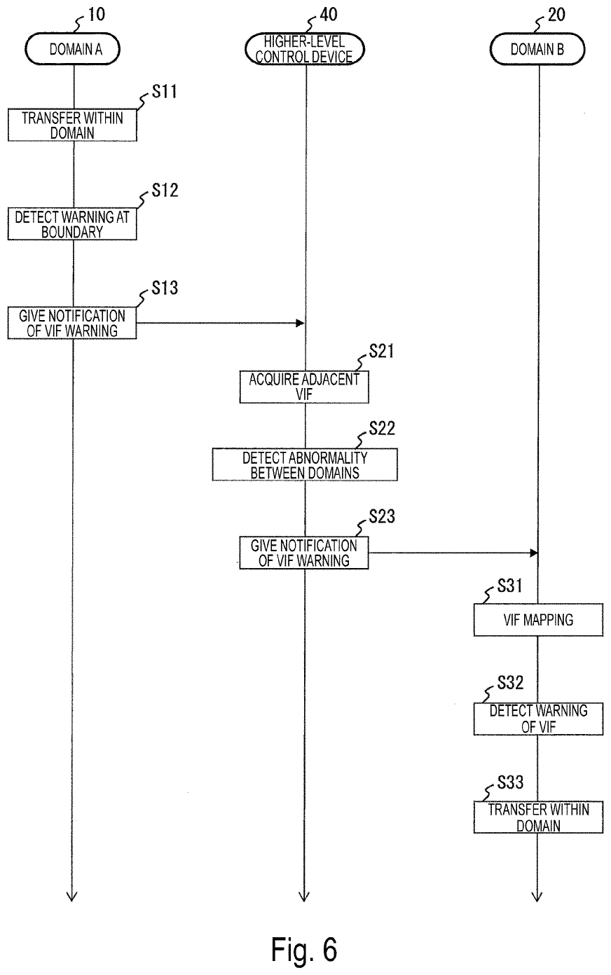

Note that the components in the configuration diagram in FIG. 5 and the components in the configuration diagram in FIG. 3 have the same component names, but have different reference numerals and signs. Processing in FIG. 6 will be described in detail using the components in FIG. 5.

FIG. 6 is a sequence diagram illustrating an operation of the communication system when a warning is generated.

As S11, in a case where a failure occurs in one port of the relay node 12 of the domain A10 and no optical signal is generated, an internal warning (LOS signal) is transferred within the domain. By in-bound control based on the internal warning, a failure point warning suppression process and a redundant switching process are executed in the domain A10.

As S12, when the internal warning in S11 reaches the boundary node 13 of the domain A10, the internal connection unit 137 of the VIF management unit 13c detects an internal warning.

On the other hand, the internal connection unit 137 may detect not only an internal warning from the relay node 12, but also a warning detected by the optical transmission and reception unit 30 connected to the boundary node 13 through the VIF 13v as the internal warning (from the VIF 13v) of the domain A10.

As S13, the conversion unit 136 converts (maps) the internal warning detected in S12 into the VIF warning (LOS signal) of the VIF 13v. The external connection unit 135 notifies the VIF connection unit 412 of the higher-level control device 40 of the converted VIF warning.

As S21, the VIF connection unit 412 acquires, with respect to the VIF 13v of the VIF warning notified in S13, an adjacent VIF 21v (information indicating a VIF of the boundary node 21) from the VIF higher-level management unit 411.

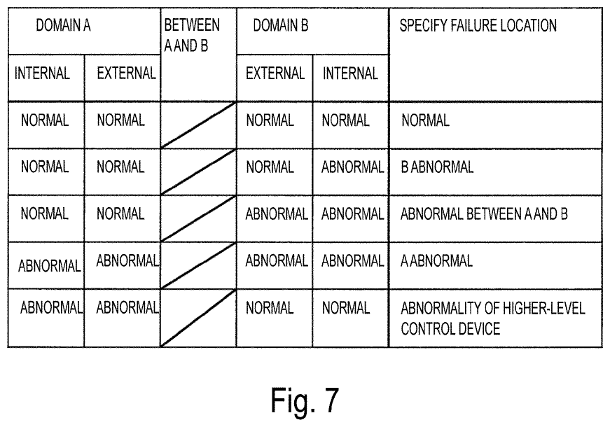

As S22, the abnormality detection unit 413 detects an abnormality between the domains from the notified VIF warning (details are illustrated in FIG. 7). In addition, the VIF higher-level management unit 411 may collate the topology stored in the database 402 with the notified VIF warning to specify where a fault has occurred (that is, what is the cause of a warning).

As S23, the VIF connection unit 412 notifies the VIF management unit 21c that manages the adjacent VIF 21v of the notified VIF warning.

As S31, the external connection unit 215 of the VIF management unit 21c maps the VIF warning notified in S23 as a VIF warning (LOS signal) of the VIF 21v and passes the VIF warning to the internal connection unit 217.

As S32, the internal connection unit 217 detects the VIF warning of the VIF 21v in S31 as a warning within the domain B20, and creates an internal warning of the domain B20 based on the detection result. In other words, the conversion unit 216 converts the VIF warning of the VIF 21v into an internal warning of the domain B20.

As S33, the internal warning in S32 is transferred within the domain B20 (the boundary node 21→the relay node 22→the boundary node 23), and thus in-bound control is performed as a single vendor within the domain B20.

In the sequence described above, out-bound control performed by the higher-level control device 40 is reduced to S21 to S23, and the others are in-bound controlled within each domain. Thus, the burden on the higher-level control device 40 is greatly reduced.

FIG. 7 is a configuration diagram of a table which is used for processing of the abnormality detection unit 413. Similarly to FIG. 6, a case where a warning is transferred from the domain A10 to the domain B20 will be described.

The table is a table for the abnormality detection unit 413 to specify a failure location based on a combination of details (any one of a normal state and an abnormal state) of a warning of each of the inside (internal warning) and the outside (VIF warning) for each domain. As described below, the abnormality detection unit 413 determines an abnormality between systems by confirming a combination of states of VIFs of an adjacent system both upstream and downstream.

A first row of the table indicates a case where a warning indicating an abnormality has not been received in both the domain A10 and the domain B20, and indicates a normal state throughout a network.
A second row of the table indicates a case where a warning indicating an abnormality has been received only within the domain B20, and it can be understood that there is a failure location inside the domain B20.
A third row of the table indicates that an abnormality occurs between domains because a state changes from a normal state to an abnormal state outside the adjacent domain A10 and outside the domain B20.
A fourth row of the table indicates a case where a warning indicating an abnormality has been received in both the domain A10 and the domain B20, and it can be understood that there is a failure location inside the domain A10 which is the most upstream side where a warning flows.
A fifth row of the table indicates a case where an abnormality has not been detected in the domain B20 located downstream in spite of an abnormality having been detected in the domain A10 located upstream, and it can be understood that there is an abnormality in the higher-level control device 40 that relays a warning between the domains.

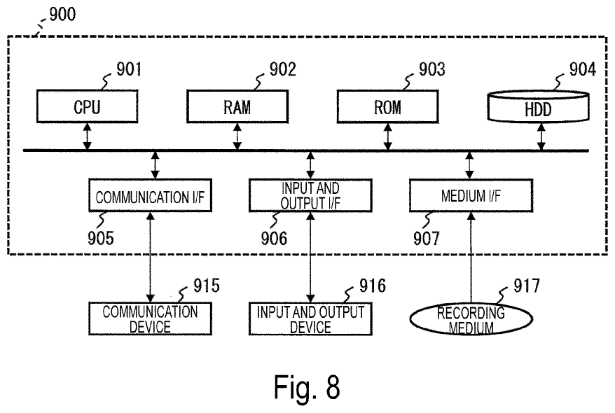

FIG. 8 is a configuration diagram of a computer which is used in a communication system.

The devices of the communication system such as the nodes (the boundary node 11, the relay node 12, and the like), the VIF management (the VIF management unit 11c, and the like), and the higher-level control device 40 in FIG. 2 are configured as a computer 900 including a CPU 901, a RAM 902, a ROM 903, an HDD 904, a communication I/F 905, an input and output I/F 906, and a medium I/F 907.

The communication I/F 905 is connected to an external communication device 915. The input and output I/F 906 is connected to the input and output device 916. The medium I/F 907 reads and writes data from a recording medium 917. Further, the CPU 901 controls the processing units by executing a program (also referred to as an application or an app that is an abbreviation thereof) which is read into the RAM 902. In addition, the program can also be distributed through a communication line or recorded and distributed on the recording medium 917 such as a CD-ROM.

### Advantages

In the present invention, the domain A10 including one or more boundary nodes 13 is provided with the VIF 13v which is a virtual connection unit for the adjacent domain B20, the domain B20 including one or more boundary nodes 21 is provided with the VIF 21v which is a virtual connection unit for the domain A10, the warning communication device is configured as the boundary node 13 and the boundary node 21, the boundary node 13 receives an internal warning in a format capable of being processed within the domain A10, converts the internal warning into a VIF warning, which is a warning of a virtual IF capable of being processed in common between the domains, and then notifies the VIF 21v adjacent to the VIF 13v of the VIF warning, and the boundary node 21 converts the VIF warning of the VIF 21v into an internal warning in a format capable of being processed within the domain B20 and then transfers the internal warning to another node within the domain B20.

Thereby, because the relay node 12 is omitted from the node that notifies the higher-level control device 40 of the VIF warning, and only the boundary node 13 at the endpoint of the system is confirmed, the number of warnings processed by the higher-level control device 40 and a monitoring point of the higher control device 40 are suppressed. Thus, a load is not concentrated on the higher-level control device 40, thereby improving the scalability of the overall communication system.

The present invention is configured to include the warning communication device and the higher-level control device 40 that controls the domain A10 and the domain B20, and the higher-level control device 40 specifies whether or not a failure is a failure within the domain A10, a failure within the domain B20, or a failure between the domains based on combinations of normal state and abnormal states of an internal warning within the domain A10, a VIF warning of the VIF 13v, a VIF warning of the VIF 21v, and an internal warning within the domain B20.

Thereby, the higher-level control device 40 can specify a failure location indicated by a warning from a wide range over a plurality of domains. Thus, maintenance personnel of a network can efficiently recover a fault by identifying a warning of a cause from among warnings.

### REFERENCE SIGNS LIST

10 Domain A (first domain)

11, 13, 14, 16 Boundary node (first node)

12, 15 Relay node

11c, 13c VIF management unit

11v, 13v VIF (first virtual IF)

20 Domain B (second domain)

21, 23, 24, 26 Boundary node (second node)

22, 25 Relay node

21c, 23c VIF management unit

21v, 23v VIF (second virtual IF)

30 Optical transmission and reception unit

40 Higher-level control device

1. A warning communication device comprising:
a first node and a second node, a plurality of the first nodes being included in a first domain having a first virtual IF which is a virtual connection unit for virtual connection with an adjacent second domain having a second virtual IF which is a virtual connection unit for virtual connection with the first domain, and a plurality of the second nodes being included in the second domain,
wherein the first node notifies the second virtual IF adjacent to the first virtual IF of a virtual warning by receiving a first internal warning in a format capable of being processed within the first domain, and converting the first internal warning into the virtual warning which is a warning of a virtual IF capable of being processed in common between the domains, and
the second node transfers the second internal warning to another node in the second domain by converting the virtual warning of the second virtual IF into a second internal warning in a format capable of being processed within the second domain.

2. A communication system comprising:
the warning communication device according to claim 1; and
a higher-level control device configured to control the first domain and the second domain,
wherein the higher control device specifies whether or not a failure is a failure within the first domain, a failure within the second domain, or a failure between the domains based on combinations of a normal state and an abnormal state of the first internal warning within the first domain, the virtual warning of the first virtual IF, the virtual warning of the second virtual IF, and the second internal warning within the second domain.

3. A warning communication method in which a first domain including one or more first nodes is provided with a first virtual IF which is a virtual connection unit for virtual connection with an adjacent second domain, and the second domain including one or more second nodes is provided with a second virtual IF which is a virtual connection unit for virtual connection with the first domain, and the warning communication device includes the first node and the second node, the warning communication method comprising:
notifying the second virtual IF adjacent to the first virtual IF of a virtual warning by causing the first node to receive a first internal warning in a format capable of being processed within the first domain, and converting the first internal warning into the virtual warning which is a warning of a virtual IF capable of being processed in common between the domains, and
transferring the second internal warning to another node in the second domain by causing the second node to convert the virtual warning of the second virtual IF into a second internal warning in a format capable of being processed within the second domain.

4. A warning communication program comprising:
causing a computer as a warning communication device to execute procedures, in which a first domain including one or more first nodes is provided with a first virtual IF which is a virtual connection unit for virtual connection with an adjacent second domain, and the second domain including one or more second nodes is provided with a second virtual IF which is a virtual connection unit for virtual connection with the first domain,
wherein the warning communication device includes the first node and the second node, and
the procedures include a procedure of notifying the second virtual IF adjacent to the first virtual IF of a virtual warning by causing the first node to receive a first internal warning in a format capable of being processed within the first domain, and converting the first internal warning into the virtual warning which is a warning of a virtual IF capable of being processed in common between the domains, and a procedure of transferring the second internal warning to another node in the second domain by causing the second node to convert the virtual warning of the second virtual IF into a second internal warning in a format capable of being processed within the second domain.
